(19) United States
(12) Patent Application Publication
(10) Pub. No.: US 2023/0094492 A1
(43) Pub. Date: Mar. 30, 2023

(54) ADSORBENT-TYPE STORAGE AND DELIVERY VESSELS WITH HIGH PURITY DELIVERY OF GAS, AND RELATED METHODS

(71) Applicant: ENTEGRIS, INC., Billerica, MA (US)

(72) Inventors: Oleg Byl, Southbury, CT (US); Joe R. Despres, Middletown, CT (US); Ed A. Sturm, New Milford, CT (US)

(21) Appl. No.: 17/952,996

(22) Filed: Sep. 26, 2022

Related U.S. Application Data
(60) Provisional application No. 63/249,859, filed on Sep. 29, 2021.

(51) Int. Cl. F17C 11/00; B01D 53/04; B01J 20/20; F17C 7/00

(52) U.S. Cl. CPC F17C 11/007; B01D 53/0407; B01J 20/20; F17C 7/00; B01D 2253/304; B01D 2253/308; B01D 2253/20; F17C 2201/058; F17C 2201/06; F17C 2221/033; F17C 2223/0123; F17C 2270/01

(57) ABSTRACT

Described are storage and dispensing systems, and related methods, for storing and selectively dispensing high purity reagent gas from a storage vessel in which the reagent gas is held in sorptive relationship to pyrolyzed carbon adsorption particles.

### CROSS-REFERENCE TO RELATED APPLICATIONS

This application claims the benefit under 35 USC 119 of U.S. Provisional Patent Application No. 63/249,859, filed Sep. 29, 2021, the disclosure of which is hereby incorporated herein by reference in its entirety.

### FIELD

The following description relates to storage and dispensing systems, and related methods, for storing and selectively dispensing high purity reagent gas from a storage vessel in which the reagent gas is held in sorptive relationship to a solid adsorbent medium.

### BACKGROUND

Gaseous raw materials (referred to sometimes as “reagent gases”) are used in a range of industries and industrial applications. Some examples of industrial applications include those used in processing semiconductor materials or microelectronic devices, such as ion implantation, expitaxial growth, plasma etching, reactive ion etching, metallization, physical vapor deposition, chemical vapor deposition, atomic layer deposition, plasma deposition, photolithography, cleaning, and doping, among others, with these uses being included in methods for manufacturing semiconductor, microelectronic, photovoltaic, and flat-panel display devices and products, among others.

In the manufacture of semiconductor materials and devices and various other industrial processes and applications, there is ongoing need for reliable sources of highly pure reagent gases. Examples of reagent gases include silane, germane (GeH₄), ammonia, phosphine (PH₃), arsine (AsH₃), diborane, stibine, hydrogen sulfide, hydrogen selenide, hydrogen telluride, halide (chlorine, bromine, iodine, and fluorine) compounds, among others. Many of these gases must be stored, transported, handled, and used with a high level of care and with many safety precautions due to toxicity of the reagent gases, due to inherent instability of the reagent gases, or both.

One useful technique for increasing safe storage of reagent gases is to store a reagent gas in an adsorbed state on a solid adsorbent material. Some storage systems (referred to herein as “adsorbent-based” storage systems) include a storage vessel that contains reagent gas that is adsorbed on a solid adsorbent material also within the storage vessel. The adsorbed reagent gas may be contained in the vessel in equilibrium with an amount of the reagent gas also present in condensed or gaseous form in the container. Advantageously, the vessel can contain the reagent gas in a highly concentrated form, i.e., the vessel may contain 100 percent reagent gas without any other type of stabilizing or diluent gas that is sometimes otherwise included with a stored reagent gas. In specific, high pressure storage systems that do not involve an adsorbent, that store reagent gas in a high pressure container, often or typically combine the stored reagent gas with an inert gas such as hydrogen, helium, nitrogen, or the like, to dilute the reagent gas. The diluted gas is more stable, less prone to explosion or fire, and less toxically potent.

A different advantage of adsorbent-type storage systems is the ability to store a usefully large volume of reagent gas within the vessel at a low pressure, e.g., a sub-atmospheric pressure, so that in the event of a breach of the vessel the reagent gas will not tend to escape from the vessel interior.

For commercial use, a gaseous raw material must be delivered in a highly pure form, and must be available in a packaged form that provides a reliable supply of the gas for efficient use of the gas in a manufacturing system. Various process steps and techniques have been described for generally reducing amounts of impurities contained within an adsorbent-based storage system when preparing the system for use. See, patent publication WO 2017/079550.

Current commercial adsorbent-type storage systems are used to store, transport, handle, and deliver many varieties of highly pure reagent gases for selective delivery from the vessel. These storage systems can deliver reagent gases that contains relatively low levels of impurities, such as amounts of atmospheric impurities (nitrogen (N₂), carbon monoxide (CO), carbon dioxide (CO₂), methane (CH₄), and water vapor (H₂O)) that are below 10,000 ppmv (parts per million based on volume), measured as a total amount of nitrogen (N₂), carbon monoxide (CO), carbon dioxide (CO₂), methane (CH₄), and water vapor (H₂O). For some reagent gases the total amount of these atmospheric impurities may be as low as 5,000 ppmv, and for other reagent gases the amount may be as low as 500 ppmv. But there remains ongoing need for improved adsorbent-type storage systems that deliver reagent gas that contains increasingly lower levels of impurities.

Based on current and previous commercial methods of preparing adsorbent-type storage and delivery systems, suppliers of these products have not developed methods and techniques to process and assemble commercially available storage systems that achieve significantly lower levels of atmospheric impurities, including levels of total atmospheric impurities that are well below 500 ppmv (“total atmospheric impurities” being measured as a total (combined) amount of nitrogen (N₂), carbon monoxide (CO), carbon dioxide (CO₂), methane (CH₄), and water vapor (H₂O )). Additionally, commercial products do not include large volume (e.g., greater than 10 or 20 liters) adsorbent-type storage systems for supplying large stored volumes of certain types of reagent gases (e.g., germane, phosphine, arsine), in concentrated form (non-diluted, and at a delivered concentration of greater than 90 or 99 percent by volume), to commercial processes that use higher amounts (by volume) of the reagent gases, or higher flow rates of the reagent gases.

### SUMMARY

Many important reagent gases are presently available commercially in adsorbent-type storage systems that contain the reagent gas at sub-atmospheric pressure, but in small volume containers. Example products involve a low-pressure vessel that contains an adsorbent in a monolithic (non-particle) block form, with the vessel having a relatively small total internal volume. The “low-pressure” vessels are not designed to be used to contain a gas in a pressurized form, require welded cylinder construction, and must be used only with a special Department of Transportation (DOT) permits. The vessel interiors have volumes that are less than 10 liters, e.g., less than 8 liters. These products, with their small-volume format, do not lend well to applications that require a larger supply (a larger stored volume) of reagent gas because of a need for a higher use rate or a higher flow rate of the reagent gas as delivered.

There is a need for adsorbed reagent gas storage and delivery systems that have increased volumes, that are capable of delivering a greater volume of reagent gas at a relatively high flow rate, and in a non-diluted highly concentrated form (e.g., not combined with inert diluent gas) with the reagent gas also having high purity and safety features that allow for commercial storage, transport, and use of the reagent gas.

In one aspect the invention relates to a storage system for storing adsorbed reagent gas. the system includes: a high pressure storage vessel comprising an interior that contains nano-porous pyrolyzed carbon adsorbent particles, and reagent gas adsorbed on the adsorbent particles, wherein a pressure at the interior is below 1500 torr.

In another aspect the invention relates to a storage system for storing adsorbed reagent gas. The system includes a high pressure storage vessel comprising: polished sidewall surfaces having a roughness of less than 1 nanometer (Ra), non-welded sidewalls and bottom, a volume of at least 10 liters and nano-porous pyrolyzed carbon adsorbent particles contained in the vessel.

In yet another aspect the invention relates to a method of preparing carbon adsorption particles within a high pressure vessel. The method includes: forming synthetic polymer carbon precursor resin particles; pyrolyzing the precursor resin particles in an inert atmosphere to produce nano-porous pyrolyzed carbon adsorbent particles; placing the pyrolyzed carbon adsorbent particles into a high pressure storage vessel while containing the particles and the vessel in an inert gas atmosphere; exposing the pyrolyzed carbon adsorbent particles in the vessel to elevated temperature and reduced pressure, and filling the vessel with the reagent gas.

### DETAILED DESCRIPTION

The present disclosure relates to storage systems for storing reagent gas on nano-porous pyrolyzed carbon adsorbent particles contained within a high-pressure vessel, for selectively dispensing the reagent gas from the high-pressure vessel. In use, the high-pressure vessel contains the adsorbent, adsorbed reagent gas, and a low level of impurities, at a relatively low pressure. The vessel has a relatively large volume to contain a high volume of the stored reagent gas even at a relatively low pressure. The high volume vessel is capable of dispensing a high volume and a high volumetric flow rate of the reagent gas in a non-diluted form, to a process or apparatus that uses the reagent gas.

Advantageously, a high-pressure and high-volume storage vessel used with nano-porous pyrolyzed carbon adsorbent particles to store and deliver adsorbed reagent gas allows for a high storage and high delivery capacity even without the reagent gas being stored at high pressure within the storage vessel. Based on example systems as described, the stored reagent gas can be delivered from the vessel, after storage, at a high purity level by using highly pure nano-porous pyrolyzed carbon adsorbent particles that are prepared by pyrolysis of a high purity carbon source (e.g., a high purity synthetic carbohydrate resin), and by using methods of processing the adsorbent particles, vessel, and reagent gas, during preparation and assembly, that will control or minimize exposure to impurities and control or minimize surface chemical activity of the carbon adsorbent with the adsorbed reagent gas.

The systems are useful as storage and dispensing systems that allow for any of various reagent gases to be stored on the adsorbent within the vessel, and to be selectively desorbed from the adsorbent and dispensed (delivered) from the vessel under fluid dispensing conditions. Example systems are prepared from materials and processing steps that reduce or avoid contact of the adsorbent, reagent gas, and vessel with impurities, such as atmospheric impurities, or with steps that remove such impurities from the system. Preferred systems contain a very low level of impurities that can become present in the reagent gas as dispensed. Preferred systems are able to dispense a reagent gas from the vessel with the delivered reagent gas containing a comparably low amount of atmospheric impurities, e.g., a low amount of one or more of: nitrogen (N₂), carbon monoxide (CO), carbon dioxide (CO₂), methane (CH₄), and water vapor (H₂O), individually; and a low total (combined) amount of these impurities measured together.

A useful storage vessel can be a vessel that is designed for containing a reagent gas at high pressure. Generally, a vessel referred to herein as a “high-pressure vessel” or a “high-pressure container” or a “high-pressure cylinder” is a storage vessel that is designed and rated for storing and transporting gaseous contents, or a combination of liquid and gaseous contents, at high pressure, such as at a pressure in excess of 500 pounds per square inch (psi). The reason for use of a “high-pressure vessel” in systems or methods as described is for an added level of safety when storing and transporting a large volume of reagent gas in a large (high volume) storage vessel. While the vessel is designed for use to contain a gas at a high pressure, such as at least 500 psi, the system and methods may be used to store reagent gas at a pressure that is not considered to be a high pressure, and that may be as low as atmospheric pressure or sub-atmospheric pressure.

Example high-pressure vessels include vessels defined as high pressure vessels and regulated as to their use in transportation by the United States Department of Transportation (DOT), the Occupational Safety and Health Association (OSHA), the Compressed Gas Association (CGA), or two or more of these. See e.g., DOT specifications 3E, 3AA and 3AAX. A high-pressure vessel that will be useful according to the present description may desirably meet the requirements of DOT 3E, DOT 3AA or DOT3AAX, having a “service capacity” of at least 150 psi (gauge) or 500 psi (gauge) (see 49 C.F.R. section 178.37 “Specification 3AA and 3AAX seamless steel cylinders”) But a vessel for use according to the present description does not necessarily need to meet all of those requirements for the vessel to be useful as described, and high-pressure vessels that do not meet all DOT requirements may still be effective for use according to the present description.

A high-pressure vessel is typically a metal cylinder that includes cylindrical sidewall, a bottom that may be flat or domed, and an upper curved shoulder of gradually reduced diameter that connects the upper portion of the sidewalls to a collar that includes a top opening of the cylinder that is adapted to receive a valve to enclose an interior space within the cylinder. A typical high-pressure cylinder is a seamless metal cylinder, meaning a metal cylinder that contains sidewalls and a bottom that are made of a single, continuous (“seamless”) piece of metal, and is produced by steps that do not include connecting two separately prepared metal pieces at a seam or a lap, meaning for example by a method of welding, brazing, or the like.

Examples of high-pressure vessels are prepared by known methods, with some example methods being referred to as a “plate drawn method,” a “blown bottle method,” and a “hot billet pierce method,” each of which forms a high strength metal cylinder with a seamless cylindrical structure, particularly a cylinder that does not include a seam (e.g., a weld) at a location of the cylinder sidewalls connecting to the cylinder bottom. Because the finished vessel does not contain a seam formed by contact between two edges of separately prepared pieces, the method of preparing the vessel does not require a step of bonding two pieces together along edges of the two pieces by a step of welding or brazing the two pieces at their edges.

For use as described herein, to preferably provide a high storage volume (a high storage capacity of reagent gas) and a high volume of flow of reagent gas dispensed from the vessel at very high purity, in comparison to other adsorbent-type storage systems, the storage vessel of a system as described can have an interior volume that is greater in size than volumes of typical low pressure adsorbent-type storage systems.

Many adsorbent-type storage systems use non-high pressure (or “low pressure”) storage vessel that have a volume of below 8 liters, e.g., below 5 liters. Examples of such low pressure (low volume) adsorbent-type storage system vessels contain adsorbent in monolithic form, e.g., a vessel contains one or a few to several monolithic blocks of adsorbent. These systems store reagent gas adsorbed onto the monolithic adsorbent at low (typically sub-atmospheric) pressure in a “low pressure” metal container prepared by welding pieces of the vessel together to form a welded seam in the vessel structure. The welded vessel is compatible with the use of monolithic adsorbent, because monolithic adsorbent cannot be passed through a top opening of a conventional non-welded vessel.

In contrast, example high-pressure vessels as described herein do not contain a welded structure (do not contain a seam formed by a step of welding or otherwise joining two pieces of metal together), and can have an interior volume of at least 2 liters, at least 5 liters or at least 10 liters, e.g., up to or greater than 20, 30, 40 or 50 liters.

Also preferred as a way to reduce the presence of impurities in a vessel that contains adsorbent and reagent gas as described, a high-pressure vessel (e.g., a steel, seamless vessel) can have a polished interior surface that exhibits a lower surface area and lower potential for retaining adsorbed impurities, as compared to a non-polished interior surfaces. A useful or preferred interior of a vessel as described can have a surface roughness (Ra) of less than 1 micron over a major portion of the interior surface, preferably over all, of or substantially all, of the interior surface area of the vessel.

A high-pressure vessel is typically made of a high strength metal such as steel or aluminum, with examples including high strength chromium-molybdenum steel and high strength carbon steel.

A high-pressure vessel is typically made of sidewalls and a bottom that have a thickness that is greater than vessels that are rated for non-high pressure use (“low-pressure containers”). Examples of sidewall thickness of a high-pressure vessel may be at least 5 millimeters.

Accordingly, preferred systems as described include a high-pressure vessel that contains adsorbent for storing and transporting reagent gas. The adsorbent is a pelletized form of a highly pure pyrolyzed carbon formed by pelletizing and pyrolyzing (by any useful steps, in any order) a carbon source to produce pelletized carbon adsorbent. The carbon source may be synthetic hydrocarbon resin such as polyacrylonitrile (PAN), sulfonated polystryrene-divinylbenzene (PS-DVB), polyvinylidene chloride (PVDC), polyether etherketone (PEEK), polyetherimidie (PEI), phenolic, polyfurfuryl alcohol (PFA), or naturally occurring hydrocarbon source such as starch, coal tar pitch, microcrystalline cellulose, or maltodextrin, etc. This type of adsorbent may be referred to herein as “pyrolyzed carbon adsorbent particles,” “pelletized carbon adsorbent,” or sometimes merely “the adsorbent,” for short. A preferred carbon source may be a synthetic hydrocarbon resin that has a low amount of chlorine (Cl2) contamination. A useful or preferred synthetic hydrocarbon resin (e.g., PVDC) may contain chlorine as an impurity at a level below 120 ppm (mass) residual chlorine, such as at a level that is below 50 ppm (mass) via XRF (x-ray fluorescence) or PIXE (proton induced x-ray emission).

Example methods of forming pyrolyzed carbon from a carbon source are described in U.S. Pat. No. 6,132,492, and PCT patent publication WO 2017/079550, the entireties of each of these being incorporated herein by reference.

The adsorbent as used in a system or method of the present description is non-monolithic (i.e., pelletized, or “pellets,” or “particles”) pyrolyzed carbon adsorbent. The adsorbent is referred to as “pyrolyzed” carbon adsorbent because the adsorbent is prepared by a step of pyrolyzing a carbon source.

The adsorbent is non-monolithic, meaning that the adsorbent is in the form of “particles” (a.k.a. “pellets”) as these terms are known and used in the art of adsorbent materials. Consistent therewith, a “monolithic” adsorbent refers to adsorbent material in a form of from one to several relatively large-dimension block-type pieces contained in a storage vessel, as opposed to a collection of a very large number (a “multitude”) of small (e.g., centimeter or millimeter-scale) particles or pellets contained within a vessel. Monolithic adsorbent may be in the form of blocks, bricks, three-dimensional discs (“pucks”) that may be stacked within a vessel, boules, etc., generally with dimensions that are on a scale of centimeters or larger, and that due to size and shape features are too large to be passed through a top opening of a typical high pressure, seamless, non-welded storage vessel.

In comparison, pelletized adsorbent is understood to be in the form of a large number of individual separate adsorbent pieces having shapes referred to as beads, particles, granules, pellets, or the like, with typical dimensions (e.g., particle size in terms of average diameter) being on a scale of less than one centimeter, e.g., less than 0.5 centimeter.

In a vessel that contains a multiplicity of adsorbent particles, the space at the vessel interior will contain the particles and “void space,” which refers to a portion (volume) of the interior that is located between particles and is not taken up by the volume of the particles (void space does not include “headspace” of a vessel, which refers to an amount of space at an upper portion of the vessel, above particles contained in the vessel. Void space in a vessel is space that is present between particles contained in the vessel, and that forms a network of interconnected pathways between surfaces of the particles, within which gas can be present or may flow. The amount of void space in a vessel that contains adsorbent particles will vary according to the dimensions, shape, and packing density of the adsorbent particles.

Non-monolithic adsorbent particles in the form of a collection of a large number of particles or pellets can be particularly effective for use in a high-pressure vessel because the particles can be readily passed through a top opening of a high-pressure vessel (before a valve is secured to the top opening), whereas monolithic adsorbent does not pass through a top opening of a high-pressure vessel. The collection of particles can be effectively fluidic, allowing the particles to be poured, blown, allowed or forced to flow through a conduit (pipe or straw), or otherwise passed through a top opening of a high-pressure storage vessel, which has an opening size (diameter) that is substantially larger than dimensions of individual particles of the adsorbent.

The pyrolyzed carbon adsorbent particles can be formed, handled, and processed to exhibit properties that provide useful or advantageous performance for use as an adsorbent for storing and delivering (adsorbing and selectively desorbing) reagent gas. Generally, these properties include high purity (very low levels of impurities) in combination with physical properties that have combined effects that allow the adsorbent: to be easily added to a vessel interior through a top opening of a high-pressure vessel; to be contained within the vessel at a relatively high density (e.g., bulk density) with an acceptably low void space (void volume) between the particles; and to adsorb a high volume of reagent gas (even at a low pressure, such as a sub-atmospheric pressure within a storage vessel) that may be desorbed for delivery from the vessel by selective desorption.

In the described systems and methods, a high volume, high-pressure vessel is used to contain a large amount (by volume) of reagent gas, with an added degree of safety provided by the high pressure rating of the high-pressure vessel. Using the high-pressure vessel with a relatively large volume in combination with highly-pure pelletized, pyrolyzed carbon adsorbent, methods and systems as described can store and transport a high volume of reagent gas (i.e., exhibit a high storage capacity), and are able to deliver a large volume of very high purity (as delivered) reagent gas, at a high flow rate.

As one useful physical property of pyrolyzed carbon adsorbent particles, the adsorbent can be formed as particles that have a size that will easily pass through a top opening in a storage vessel, and that will also be contained within the vessel in a high density (a high packing density, measured to include void space between particles), e.g., with a desirably low void space present between the particles.

Useful particles of the adsorbent can have an average size that is in a range from 0.5 to 20 millimeters, such as from 1 to 15 or from 1 to 10 millimeters (mm). Average particle size for a collection of adsorbent particles can be measured by standard techniques, including random selection of particles from a collection of particles and measuring size (e.g., diameter) by use of a micrometer.

Useful or preferred particles can also have a shape that in combination with the average size will produce a relatively high packing density and a relatively low void space. Example shapes are rounded shapes, including particles that are substantially rounded, substantially spherical, or cylindrical, or other dense packing or “space filling” form or shape such as space filling polyhedra. Examples of preferred amounts of void space between adsorbent particles (which does not include headspace within a vessel) as the particles are contained within a high-pressure container may be below 50 percent, e.g., below 40, 30, or 25 percent.

Useful or preferred pyrolyzed carbon adsorbent particles can have a bulk density (“bulk density” or “packing density” is density measured to include density (mass per volume) of a sample volume of particles within a confined volume, with the volume including void space between particles) that is at least 0.55 or 0.60 grams per cubic centimeter, such as at least 0.65 grams per cubic centimeter, e.g., in a range from 0.60 to 0.75 grams per cubic centimeter, from 0.6 to 0.85 grams per cubic centimeter, from 0.65 to 0.95 grams per cubic centimeter or from 0.60 to 0.95 grams per cubic centimeter, when contained within a storage vessel. To achieve this density the particles may be forced to settle together or be lightly compressed or compacted against a bottom of the container, e.g., “tapped down” with pressure applied to the particles from above the particles, or by causing deceleration of the particles against a bottom of a vessel by dropping or pounding the container onto a solid surface, or by another technique, such that the weight (force) of the decelerating particles compresses the particles toward the bottom of the vessel.

The pyrolyzed carbon adsorbent particles can also be formed as particles that have a relatively high particle density, meaning the density of a single particle and not including any void space between particles (as with the bulk density measurement). Example adsorbent particles can have a particle density of at least 0.8 gram per cubic centimeter, preferably at least 1.0 grams per cubic centimeter or at least 1.1 grams per cubic centimeter, such as in a range from 0.85 to 1.15 grams per cubic centimeter or 1.05 to 1.15 grams per cubic centimeter. The pyrolyzed carbon adsorbent particles can be formed as particles that are porous, that include an interconnected network of pores extending between the solid pyrolyzed carbon of the particles. The pores have any useful pore size, meaning any pore size that will allow for desired performance of the adsorbent in terms of storage capacity of a vessel that contains the adsorbent particles, and purity of reagent gas that is stored in an adsorbed state on the pyrolyzed carbon adsorbent and then desorbed and delivered as reagent gas.

Pore sizes of carbon adsorbent materials are classified in general ranges based on average pore size of particles. Particles that have an average pore size of greater than 50 nanometers (nm) are typically referred to as macroporous. Particles that have an average pore size in a range from 2 to 50 nanometers (nm) are typically referred to as mesoporous particles. Particles that have an average pore size of less than 2 nanometers are typically referred to as microporous. These terms are defined by IUPAC terminology.

The term “nano-porous” does not have a standard meaning in the arts of adsorbent materials. In the present description, the term “nano-porous” is used to describe particles that have an average pore size below 5 nanometers (50 angstroms). Useful or preferred carbon adsorbent particles may be “nano-porous,” meaning that the particles have an average pore size that is below 50 angstroms, or below 40, below 30, below 20 angstroms, or below 10 angstroms. Particularly preferred adsorbent particles can have an average pore size that is below 10 or20 angstroms, such as in a range from 3 to 9 angstroms, from 3 to 15 angstroms, from 5 to 8 angstroms, or from 5 to 12 angstroms. Pore size can be measured by known techniques, such as by probe molecule porosimetry, and optimal pore size can be a function of the reagent gas to be adsorbed and the desired desorption kinetics during delivery.

Another property of adsorbent particles is porosity or “pore volume”, which is an amount (in terms of percentage or unit of volume per mass of adsorbent) of a single adsorbent pellet that is taken up by pores relative to a total volume of the pellet. Example adsorbent particles can have a porosity of at least 0.35 cubic centimeters per gram, preferably at least 0.40 cubic centimeters per gram, most preferably greater than 0.50 cubic centimeters per gram.

Certain physical features of pyrolyzed carbon adsorbent particles, e.g., average pore size, pore volume (“porosity”), and pore size distribution, can be affected or controlled by features of a process or material used to prepare the particles in a pyrolysis step. These features include the carbon source used to prepare the particles, presence of solvent or fugitive pore formers, and conditions used during a step of pyrolyzing the carbon to form the pyrolyzed carbon particles, or use of modification techniques after pyrolysis such as physical oxidative activation with steam or CO₂.

Useful pyrolysis methods can be performed at a temperature above 600 degrees Celsius, in an oxygen-free atmosphere, for several hours. Pyrolysis is a process of causing decomposition of the polymeric carbon source at elevated temperature under inert conditions. The inert conditions may include vacuum or inert gas coverage with a noble gas such as argon or nitrogen or a combination of inert gas plus a reducing gas to minimize the risk of oxidative burning. The inert gas cover can be delivered as a pressurization of the furnace or as a continuous purging flow of the furnace. To completely decompose the polymeric source material to high purity carbon, several hours may be required at elevated temperature. To control the decomposition of the source polymer yielding the desired pore size distribution within the resulting carbon, it is necessary to understand when decomposition is occurring and the gaseous species being evolved, and to control the rate of decomposition and gas evolution. Those practiced in the art of preparing activated carbons from polymeric sources understand these factors involved in the pyrolysis process. Achieving desired carbon porosity properties may be an iterative process and may be different for different furnaces or systems.

A useful or preferred carbon adsorbent may be of a type and character that is substantially pure before being placed into a vessel as adsorbent in a system as described. By one measure, purity of effective carbon adsorbent particles may be characterized in terms of ash content of the carbon. A useful or preferred carbon adsorbent may contain not more than 0.01 weight percent ash content as measured by a standard test, for example as measured by ASTM D2866-83 or ASTM D2866.99. Carbon purity may preferably be at least 99.99 percent as measured by a Proton Induced X-ray Emission technique (PIXE).

To prepare and assemble a storage system as described, which contains pyrolyzed carbon adsorbent particles with a very high level of purity, various steps or techniques are used to prevent the adsorbent, the vessel, and the reagent gas, during preparation of a storage vessel, from being exposed to or from contaminating atmospheric gases. Useful steps will reduce the amount of impurities that will be present within the vessel and adsorbent when preparing the vessel and adsorbent, within the reagent gas when adding the reagent gas to the vessel and adsorbent, and ultimately within the reagent gas after a storage period when the reagent gas is delivered from a storage vessel.

An example process includes: preparing particles (also sometimes referred to as “pellets”) of high purity, pelletized nano-porous adsorbent that is made from pyrolyzed carbon; placing the pyrolyzed carbon adsorbent particles at an interior of a high-pressure storage vessel by passing the adsorbent particles through an opening in the vessel; and exposing the adsorbent at the vessel interior to elevated temperature and reduced pressure to desorb and remove trace-level atmospheric impurities that may have been adsorbed upon or within the porous adsorbent particles during preparation, handling, and placement within the vessel.

Various other optional treatments of the pyrolyzed carbon adsorbent particles may be conducted in-situ (within the vessel) prior to adding reagent gas to the adsorbent-filled container, to reduce the amount of atmospheric impurities that will be present in the vessel and in the reagent as the reagent gas is discharged from the vessel after storage.

For example, a useful optional step may be to chemically passivate the pyrolyzed carbon adsorbent particles of active surface sites that could react with a particular reagent gas to be stored. Details of such treatments are dependent on the specific adsorbent that is used and the specific type of reagent gas to be adsorbed, stored, transported, and dispensed from the vessel and adsorbent. Such treatments may include physical or chemical means for neutralizing Lewis acid or base sites.

Still generally, after exposing the adsorbent at the vessel interior to elevated temperature and reduced pressure, or any additional or alternate in-situ processing of the adsorbent-containing vessel, reagent gas may be added to the vessel interior to cause or allow the reagent gas to become adsorbed onto the adsorbent and to become contained in the vessel for storage and selective delivery (discharge) from the vessel. The reagent gas may be added and contained within the vessel at any pressure, such as a super-atmospheric pressure or a sub-atmospheric. For added safety the reagent gas can be contained at a pressure that is not more than 5, 3, or 2 atmospheres, or that is below 1 atmosphere.

The reagent gas can be stored over a useful period of time within the vessel and selectively dispensed (discharged, delivered) from the vessel for use, with the dispensed reagent gas containing, for example, less than 150 parts per million (by volume) of a total amount of impurities selected from CO, CO₂, N₂, CH₄, hydrogen (H₂), and H₂O, and combinations thereof, e.g., the dispensed reagent gas may contain a total amount of these impurities that is below 50, 25, 15, or 10 ppmv.

Alternately or additionally, reagent gas as discharged can contain individually low amounts of each of one or more of the individual impurities selected from CO, CO₂, N₂, CH₄, hydrogen (H₂), and H₂O, and combinations thereof. For example, the dispensed reagent gas may contain less than 25, 20, 15, 10, or 5 ppmv of any one of these impurities. Alternately or additionally a dispensed reagent gas may contain less than 25, 20, 15, 10, or 5 ppmv of two or more different components each measured individually, e.g., less than 25, 20, 15, 10, or 5 ppmv, measured individually, of a combination of two or more of CO, CO₂, N₂, CH₄, hydrogen (H₂), and H₂O. Additionally or alternately, a useful or preferred dispensed reagent gas can contain less than 120 ppm chlorine (Cl₂), preferably less than 50 ppm chlorine.

A specific example of the described systems is an increased level of stability of germane (GeH₄) stored in a system as described, with the carbon adsorbent being derived from a highly pure synthetic polymeric resin such as polyvinylidene chloride (PVDC). Adsorbent particles derived from this type of carbon source can physically adsorb gaseous germane molecules and store the germane unreacted in an adsorbed state, on the adsorbent, with a reduced level of degradation of the germane during storage. Germane is inherently unstable. When stored within a pressurized metal cylinder, pure non-stabilized germane will decompose to some extent creating impurities and increasing cylinder pressure as the germane decomposes to germanium metal and hydrogen gas. This decomposition reaction can be self-catalyzing, possibly dangerously so. When adsorbed within the pores of the proper adsorbent (i.e. carbon), without chemical interaction, the germane molecules can be stabilized and prevent catastrophic decomposition, deflagration, or detonation. On other less pure or more highly reactive adsorbents, the adsorbed germane in contact with the adsorbent contained within a storage vessel can degenerate to form hydrogen gas within a storage container, which collects in the vessel headspace and increases the gas pressure within the storage vessel.

In example systems, when germane is stored on carbon adsorbent derived from a highly pure synthetic hydrocarbon resin such as chloride (PVDC) at room temperature (e.g., from 20 to 25 degrees Celsius) at an elevated temperature (e.g., 65 degrees C.), the amount of hydrogen that is generated within the vessel is well controlled. In a specific example, when germane is stored on carbon adsorbent derived from highly pure PVDC, in a 2.2 liter vessel, for 6 hours at 65 degrees Celsius, the amount of hydrogen in the headspace of the vessel may increase by not more than 3 percent or not more than 2 percent.

Conventionally, purity of reagent gas contained in adsorbent-type storage systems has been measured, monitored, and described in terms of the purity of reagent gas that is initially added to a vessel for storage, i.e., the purity of the reagent gas before the reagent gas is charged to the storage vessel for storage within the vessel. However, depending on the type of storage vessel, adsorbent, and their preparation and assembly, this measure of purity may not be representative of the purity of the reagent gas ultimately delivered from the vessel after transport, handling and storage.

Methods of preparing and handling pyrolyzed carbon adsorbent particles are effective to control the amount of impurities (especially, but not exclusively, atmospheric impurities) that are present in an adsorbent-type storage system that contains the pyrolyzed carbon adsorbent particles, in systems and equipment used to supply reagent gas to an adsorbent-type storage system, and to ultimately reduce impurities in reagent gas that is stored in and delivered from the adsorbent-type storage system. According to methods as described, purity of reagent gases stored in an adsorbent-containing vessel will be improved when measured as the reagent gas is delivered (dispensed, discharged) from the vessel.

According to the present description, steps and techniques that can be used for preparing, handling, and assembling components of the adsorbent-type storage system are performed in a manner to remove atmospheric impurities from components of the storage system, or to reduce or prevent exposure of the components of the storage system (especially the adsorbent) to atmospheric gases (“atmospheric impurities”) such as nitrogen (N₂), carbon monoxide (CO), carbon dioxide (CO₂), methane (CH₄), and water vapor (H₂O). Useful techniques may reduce the amounts of these atmospheric impurities that are present in a storage vessel (including adsorbent), in a system for adding reagent gas to a storage vessel, or both, to desirably reduce the amounts of these atmospheric impurities that are present in a reagent gas as the reagent gas is stored in and eventually dispensed from the storage vessel.

Users of stored reagent gases continue to require higher and higher levels of purity of reagent gases, including ever lower levels of atmospheric impurities that may be introduced to a storage vessel as part of a component of the storage vessel (e.g., adsorbent or vessel), or that may be introduced during assembly, filling, or handling of the vessel or a component of the vessel. Even more particularly, for certain applications of reagent gases, higher volumes of gases stored and transported in a single storage vessel are desired to deliver higher total volumes of a reagent gas, a higher flow rate of a reagent gas, or both, to a process. Certain uses also require the gas to be non-diluted, i.e., to not contain any added amount of inert gas or diluent gas such as hydrogen, helium, nitrogen, or the like, that is intentionally added to and mixed with the reagent gas during storage to improve safety. Preferred gases for many current processing methods may preferably be delivered with high purity and at a high concentration, in the absence of any type of inert gas or diluent gas, i.e., delivered as 80, 90, 95, 99, or essentially 100 percent reagent gas with a very low levels of impurities.

A storage system as described includes a high-pressure vessel having a relatively large interior volume (e.g., at least 10 liters), and that contains nano-porous pyrolyzed carbon adsorbent particles at an interior of the vessel. The pyrolyzed carbon adsorbent particles are effective to contain, store, and deliver reagent gas from the storage vessel. The reagent gas is adsorbed on the adsorbent and is present as a gas at the vessel interior, with a portion of the reagent gas being adsorbed by the adsorbent, and another portion being in gaseous form, or in condensed and gaseous forms that are in equilibrium with the adsorbed portion. The reagent gas can be initially charged into the vessel to a desired (e.g., maximum) capacity of reagent gas relative to the adsorbent, based on a desired initial storage pressure within the vessel, which may be a sub-atmospheric pressure (below 760 Torr) or a super-atmospheric pressure (the initial storage pressure is referred to as a “use pressure” or a “target pressure” of a fill step after equilibration of an initial amount of reagent gas). The reagent gas becomes adsorbed onto the adsorbent for storage and is present as a gaseous or condensed form in equilibrium with the adsorbed reagent gas. Subsequently, the gas can be selectively delivered (dispensed) from the vessel for use by exposing the adsorbent and adsorbed reagent gas at the vessel interior to dispensing conditions.

As used herein, “dispensing conditions” means one or more conditions that are effective to desorb reagent gas held in a vessel with adsorbent so that the reagent gas disengages from the adsorbent on which the reagent gas has been adsorbed and so the disengaged reagent gas is dispensed from the adsorbent and the vessel, for use. Useful dispensing conditions may include conditions of temperature and pressure that cause reagent gas to desorb and be released from the adsorbent, such as: heating the adsorbent (and a vessel that contains the adsorbent) to effect thermally-mediated desorption of the reagent gas; exposing the adsorbent to a reduced pressure condition to effect pressure-mediated desorption of the reagent gas; a combination of these; as well as other effective conditions.

The pressure (initial “use” pressure) at the interior of the vessel may be sub-atmospheric, meaning below about 760 Torr (absolute), or may be super-atmospheric. For sub-atmospheric storage, during storage of the vessel or during use of the vessel to store and dispense reagent gas, the pressure at the interior of the vessel may be below 760 Torr, e.g., below 700, 600, 400, 200, 100, 50, 20 Torr, or even a lower pressure.

The described vessels and methods can be useful for storing, handling, and delivering any reagent gas that may be stored as described, at equilibrium between an adsorbed portion and a condensed or gaseous portion. A high-pressure vessel as described can be particularly desirable for storing a relatively large volume of reagent gas that is hazardous (e.g., explosive or otherwise unstable), toxic, noxious, flammable, pyrophoric, or otherwise dangerous. Illustrative examples of reagent gases for which the described vessels and methods may be particularly useful include the following non-limiting examples: methane (CH₄), acetylene (C₂H₂), ammonia (NH₃), silane (SiH₄), germane (GeH₄), diphosphene (P₂H₄), phosphine (PH₃), arsine (AsH₃), diborane (B₂H₆), stibine (SbH₃), hydrogen sulfide (H₂S), hydrogen selenide (H₂Se), hydrogen telluride (H₂Te), digermane (Ge₂H₆), diacetylene (C₄H₂). For each of these compounds, all isotopes are contemplated.

According to the present description, one or more of various steps may be performed on the adsorbent, on a vessel, or during assembly (including a step of filling a vessel with reagent gas) of a storage system, to reduce amounts of atmospheric impurities that will be present in the vessel, adsorbent, and reagent gas during storage and delivery of the reagent gas.

A reduced amount of atmospheric impurities will be present in the reagent gas as the reagent gas is stored within and is delivered from the vessel, after a period of typical storage of the reagent gas within the vessel. A typical period of storage (at ambient temperature, 25 degrees Celsius) of a system as described, including a vessel with contained adsorbent and reagent gas, may be a period of weeks (e.g., 1, 2, 6, or 8 weeks) or a period of months (e.g., 3, 6, 9, or 12 months), during and after which a useful or preferred system is capable of delivering reagent gas that contains relatively low levels of atmospheric impurities as described, e.g., compared to alternative storage systems.

As one technique for reducing the presence of impurities in a storage system, particularly impurities contained by adsorbent, pyrolyzed carbon adsorbent particles may be prepared by a pyrolysis step that will reduce an amount of impurities contained in the pyrolyzed carbon adsorbent particles.

The adsorbent particles are formed by forming particles of a carbon source, e.g., a synthetic polymer carbon precursor resin such as high purity synthetic PVDC copolymer or homopolymer.

The particles are processed by a pyrolysis step by exposing particles of the carbon source to suitable pyrolysis conditions. As desired or useful, the conditions carried out in progressive fashion involving temperature ramping from an ambient starting temperature to a desired elevated pyrolysis temperature, e.g., in a temperature range of from 600° C. to 1000° Celsius. An amount of time for a pyrolysis processing step may be any effective amount of time, for example a total time in a range from 1 to 7 days, or longer, as desired. The atmosphere in which the pyrolysis step may be performed can be an inert atmosphere that is free of oxygen, carbon monoxide, carbon dioxide, and moisture. Example atmospheres include nitrogen, argon, and forming gas (a mixture of 5 percent hydrogen in nitrogen). During the pyrolysis step, the particles may be supported by or contained in non-contaminating containment structure such as quartz or graphite trays or a quartz rotary tube.

After the adsorbent particles are formed by pyrolysis, useful methods of preparing a storage system with reduced levels of atmospheric impurities can include steps and techniques for handling the pyrolyzed carbon adsorbent particles in a manner that prevents exposing the adsorbent to atmospheric gases before and as the adsorbent particles are placed into a storage vessel (e.g., following pyrolysis) and reagent gas is added to the storage vessel interior.

As one example to reduce or prevent exposure of the pyrolyzed carbon adsorbent particles to atmospheric impurities after forming and before placing the pyrolyzed adsorbent in a storage vessel, the pyrolyzed adsorbent particles may be placed into a storage vessel directly after the pyrolysis step. Pyrolyzed adsorbent can be packaged or loaded directly into a high-pressure storage vessel without being exposed to ambient environment via direct filling within a dry, inert (e.g., nitrogen or argon atmosphere), purged containment system. The pyrolyzed adsorption particles may be loaded into the high-pressure vessel while within a controlled atmosphere (e.g., dry nitrogen with optionally cooling of the surrounding environment to reduce moisture content in the atmosphere), with no exposure to ambient atmosphere (i.e., air) and within a short amount of time after the pyrolysis step, such as within 30 minutes after an end of a pyrolysis step. Because adsorption capacity of the adsorbent is reduced at elevated temperature, the adsorbent media may be transferred from a pyrolysis step to a storage vessel in a short amount of time (e.g., under 30, 20, or 10 minutes) while at elevated temperature of between 40 degrees Celsius and 65 degrees Celsius, and optionally within a dry, oxygen-depleted (e.g., containing less than 1, 0.5, or 0.1 volume percent oxygen) environment (e.g., concentrated nitrogen).

According to a single example of such a step, particles formed of synthetic polymer carbon precursor resin may be subject to a pyrolysis step in a pyrolysis furnace to form pyrolyzed carbon adsorbent particles. The pyrolyzed adsorbent particles may be discharged from the pyrolysis furnace at a discharge locus and directly placed into a high-pressure storage vessel at the discharge locus, e.g., delivered to an interior of a high-pressure gas storage and dispensing vessel as described herein. These steps may be carried out in a fabrication facility that includes an enclosure that contains the pyrolysis furnace. The enclosure may additionally contain (enclose) an adsorbent fill station at the discharge locus of the pyrolysis furnace, with the adsorbent fill station being arranged for placing the pyrolyzed carbon adsorbent particles directly into the storage vessel. The pyrolyzed carbon adsorbent particles may be placed into the vessel under a concentrated inert atmosphere (e.g., comprising at least 99 or 99.9 percent by volume of one or more of nitrogen, helium, argon, xenon, and krypton) or in a reducing atmosphere of hydrogen, hydrogen sulfide, or other suitable gas, or a combination of inert gas and reducing gas.

To further reduce the presence of atmospheric impurities in a storage system, particularly as contained by materials of the high-pressure storage vessel, the vessel interior may be prepared from a material and using process steps that will reduce the presence of atmospheric impurities at the vessel interior during use of the vessel. A vessel or other components of a storage system (e.g., valve) may be made of a material such as a metal, metal alloy, coated metal, plastic, polymer, or a combination thereof, that can be selected or processed to reduce the introduction of impurities into an interior of a storage vessel. A polished smooth, low surface roughness surface, e.g., vessel wall, can be less reactive with a reagent gas contained at a vessel interior, may adsorb less gas or moisture from its surroundings, and, therefore, may be preferred as an interior surface of a storage vessel as described. A highly polished (low surface roughness) or coated metal or performance plastic may help minimize interaction and impurities, especially with halide gases as a stored reagent gas.

Alternately or in addition, to further reduce the presence of atmospheric impurities in a storage system, particularly as contained by materials of a vessel, a vessel (of any material), before adding adsorbent, may be exposed to a heating and optional depressurization step to reduce the amount of impurities that may be contained within materials of the vessel, e.g., that are adsorbed in minute amounts within materials of the vessel, e.g., sidewalls and a bottom of the vessel, or within other components of a vessel or storage system such as a valve. A vessel or other components of the system may be made of a material such as a metal, metal alloy, coated metal, polished metal, plastic, polymer, or a combination thereof. Any of these materials may contain very small or minute amounts of adsorbed impurities such as moisture, another atmospheric impurity, or organic volatile materials.

A step of cleaning, drying, passivating, purging, or heating a vessel before adsorbent is added to and contained at the vessel interior may be performed by exposing a vessel or other components of a storage system, while the vessel does not contain adsorbent, to any suitable condition that will cause impurities that may be contained in the material to be dispelled (degassed) or otherwise removed from the material, e.g., due to high temperature, reduced pressure, by a chemical or physical mechanism, or otherwise. One or more of these steps may be performed before adding any adsorbent to the interior of the vessel.

Even the cleanest, freshest, and smoothest metal surfaces typically have a thin surface layer of metal oxide and said metal oxide layer can act as an adsorbent to soak up atmospheric impurities and moisture which may subsequently react with the reagent gas when added to the vessel. Thus, an optional step in vessel preparation may include a chemical passivation of the cleaned vessel. As a single example, a vessel targeted for containment of a reactive fluoride reagent gas, such as germanium tetrafluoride (GeF₄), phosphorous pentafluoride (PF₅), arsenic pentafluoride (AsF₅), silicon tetrafluoride (SiF₄), antimony pentafluoride (SbF₅), boron trifluoride (BF₃), boron tetrafluoride (B₂F₄), or other reactive fluoride reagent gas may advantageously undergo a passivation prior to loading of the adsorbent. For instance, pressurization of the vessel above the targeted fill pressure, preferentially above 1000 torr with a diluted mixture of fluorine (F₂) gas in a dry inert gas (i.e. nitrogen or argon) perhaps in the mixture range of 5 to 10% fluorine by volume and holding at pressure for a period of time such as greater than 5 hours. Such fluorine exposure and treatment can convert the thin surface layer of metal oxide on the interior walls of the vessel to a dense fluoride layer which is less reactive with the fluoride gas to be stored and less likely to contaminate the reagent gas with adsorbed trace atmosphere contaminants.

A step of heating a vessel with optional reduced pressure, to remove adsorbed impurities from materials of the vessel or system, may be carried out in any effective manner, at a useful temperature and pressure, including a temperature at which the material of the vessel or system is thermally stable. Certain materials used for a vessel or storage system are less stable than others, and a temperature used during a heating step will be one at which a particular material remains stable and does not degrade. The heating step may be carried out in a progressive fashion involving temperature ramping from an ambient starting temperature to a desired elevated temperature, above that which the vessel should encounter during storage, transport, and use e.g., in a temperature range of from 110° C. to 300° Celsius, with the heating step being performed over a time that may variously range from 8 to 40 hours, as desired and effective. A preferred heating step may also be performed in an evacuated atmosphere, such as at a pressure of below 650 Torr, e.g., at a pressure of below 3 Torr, or below 1×10⁻⁴ Torr, or below 1×10⁻⁵ Torr.

While being held at elevated temperature, the vessel may alternatively or additionally be cycled repeatedly between evacuation pressure and an atmosphere of dry inert purge gas, such as 1000 torr of helium, nitrogen, or argon.

As another specific technique for reducing the presence of atmospheric impurities in a storage system, particularly as contained by adsorbent, an adsorbent may be subjected to a heating and depressurization step (a “degassing step”) after the adsorbent is placed within a storage vessel, to reduce the amount of impurities present in the adsorbent. This step removes physisorbed and some chemisorbed species that may have detrimental effect on adsorbed reagent gas purity or adsorbent capacity.

A heating step may be performed on adsorbent contained in a vessel by exposing adsorbent and the vessel that contains the adsorbent to any suitable heating and pressure conditions that will remove an amount of atmospheric impurities that may be contained in the adsorbent after placement of the adsorbent within the vessel, without producing an undue detrimental thermal effect on the adsorbent or vessel. The heating step is performed before adding any reagent gas to the adsorbent and vessel interior.

A step of heating adsorbent within a vessel to remove atmospheric impurities may be carried out at in any effective manner and at a useful temperature and pressure, including a temperature at which the adsorbent is thermally stable. The heating step may optionally be carried out in a progressive fashion involving temperature ramping from an ambient starting temperature to a desired elevated temperature, e.g., in a temperature range of from 110° C. to 300° Celsius, with the heating step being performed over a time that may variously range from 8 to 40 hours, or longer, as desired and effective. A preferred heating step may be performed in an evacuated atmosphere, such as at a pressure of below 5 Torr, e.g., at a pressure of below 1×10⁻⁵ or 1×10⁻⁶ Torr.

A method as described may also involve a step of chemically passivating adsorbent after the adsorbent is placed within the vessel. A chemical passivation step may include a step of exposing surface sites of adsorbent particles to a chemical, in the form of a gas (passivation gas), to remove residual adsorbed impurities (e.g., atmospheric impurities), or to neutralize or inactivate active surface sites on the adsorbent. The amount and type of passivation gas of a passivation step and the conditions and amount of time of exposure of the passivation gas to the adsorbent can depend on the type of the adsorbent as well as the type of reagent gas that will be stored by adsorption onto the adsorbent.

As a single example, a step of chemically passivating pyrolyzed carbon adsorbent particles may be performed in a high-pressure vessel that contains the adsorbent by exposing the adsorbent to reagent gas that is the same reagent gas that will be charged into the vessel in a subsequent filling step for storage in the vessel; i.e., the reagent gas that will be stored in the vessel is used as the passivating gas in a step of passivating the adsorbent. The adsorbent may be exposed to the reagent gas at any pressure and for any amount of time that will passivate the adsorbent, chemically, by reacting with active surface sites on the adsorbent to inactivate those sites prior to the vessel being charged with the same reagent gas for the purpose of storing the reagent gas within the vessel. Optionally, the adsorbent may be exposed to a reagent gas as a passivation gas at elevated pressure but low concentration in an inert, non-reactive gas, such as diluted to a concentration of 2, 5, or 10 percent (by volume) in a mixture with inert gas, and pressurized to 1,000, 2,000, or 5,000 Torr.

For example, in a chemical passivation step the adsorbent may be exposed to the reagent gas at a relative low pressure, e.g., a pressure of below 760 Torr, such as a pressure in a range from 1, 2, 5, or 10 Torr, up to 50, 100, 200, or 500 Torr. The time of exposure of the adsorbent to the passivation gas can be any useful amount of time, for example a time in a range from 15 to 2500 minutes, e.g., from 60 to 1000 minutes. A passivation step may be carried out at ambient temperature, or at elevated temperature, e.g., a temperature in a range from 60 to 300 degrees Celsius, e.g., from 85 to 250 degrees Celsius. After a desired time of exposure of the adsorbent to the passivation gas, the passivation gas is removed from the adsorbent by exposure to reduced pressure, for example to a pressure of less than 3 Torr, e.g., a pressure of below 1×10⁻⁵ or 1×10⁻⁶ Torr.

After desired steps of preparing adsorbent and placing the adsorbent at an interior of a storage vessel, while treating the adsorbent as described to reduce or minimize the amount of atmospheric impurities to which the adsorbent is exposed or contains, the vessel can be filled (“loaded” or “charged”) with reagent gas to a desired pressure, with the reagent gas being introduced into the vessel interior and becoming adsorbed onto the adsorbent.

To reduce or control the amount of atmospheric impurities that will become present in the vessel, i.e., that may be added to the vessel or reagent gas during a step of charging reagent gas to the vessel, various steps can be performed on the vessel and adsorbent during a filling (charging) step, and certain filling equipment can be used during a filling step. These include, generally, any one or more of: the use of reagent gas of the highest possible purity or, alternately, purifying the reagent gas prior to introduction into the storage vessel; use of filling equipment that is processed, handled, and used in a manner that reduces exposure of the equipment (especially interior spaces) to atmospheric gases or to more than a single reagent gas; steps of a filling process that may be effective to remove atmospheric impurities from filling equipment and from a vessel either during or after adding the reagent gas to the vessel; any of which may be useful alone or in combinations of two or more of these.

In an example method, the reagent gas may be initially added to and held within the receiving vessel in an amount to exceed a use pressure (a.k.a. “target pressure” or “final fill pressure”) of the storage vessel (“target pressure” or “final fill pressure” refers to an initial pressure of the vessel when the vessel contains an amount of the reagent gas for use of the vessel to store, transport, and selectively released gas from the vessel for use). When initially adding the reagent gas to the vessel, the reagent gas may be added to produce an internal pressure (“initial fill pressure”) at the vessel interior that is greater than the use pressure. This initial fill pressure can be a pressure that is expected to be the maximum pressure that the vessel interior will encounter during storage, transport, and use of the vessel, when filled with the reagent gas, or a pressure below that pressure and above the use pressure. For a vessel that is designed to contain reagent gas at sub-atmospheric pressure, an example of the internal pressure of the vessel with the reagent gas added in an excess amount as described, may be a pressure of at least 760, 1000, or 1200 Torr. For example, with a target pressure (final fill pressure) of 650 Torr, the vessel may initially be filled to a range from 700 Torr to 1000 Torr, e.g. greater than 760 Torr or greater than 800 Torr, and allowed to equilibrate before being pumped back down to the target 650 Torr.

Measured differently, an example of an internal fill pressure of a vessel (designed for sub-atmospheric storage of reagent gas) with reagent gas added in an excess amount, as described, may be a pressure of at least 10, 20, or 50 percent higher than a target pressure (“use pressure”). E.g., if the vessel will contain reagent gas at a pressure of 760 Torr during use (the “use pressure,” meaning pressure of the vessel when the vessel is filled with the reagent gas for storage, transportation, and selective delivery of the reagent gas), the vessel can be filled in this initial fill step with excess reagent gas to achieve an internal pressure that is 10, 20, or 50 percent greater than the 760 Torr “use pressure,” i.e., to an internal pressure that is 836 Torr, 912 Torr, or 1,140 Torr, respectively.

After adding the reagent gas in the excess amount, the vessel is allowed to equilibrate, meaning that an amount of reagent gas adsorbed on the adsorbent, and an amount of gaseous reagent gas present as a gas in headspace volume of the vessel, come to a thermodynamic equilibrium. After adding the reagent gas in an excess amount, the vessel is held (e.g., at constant temperature) for an amount of time that is sufficient to achieve the equilibrium, with the gaseous reagent gas that is contained as a gas in the headspace potentially containing an amount of atmospheric impurities that passed from the adsorbent to gaseous reagent gas of the headspace. The reagent gas in the headspace, with the contained impurities, can then be released from the vessel to remove the impurities and to bring the vessel to a lower content of the reagent gas and to a lower pressure, e.g., to a reagent gas content and to an initial pressure as are intended for the purpose of transporting and storing the reagent gas within the vessel, e.g., a “target pressure” or a “use pressure.”

The amount of time required to reach the described equilibrium after adding the reagent gas in the excess amount may vary depending on factors such as: the type of adsorbent; the type of reagent gas; the amount of adsorbent relative to total volume of the vessel and the volume of headspace in the vessel; the amount of reagent gas added to the vessel; and the pressure at the interior of the vessel. Example amounts of time after adding the reagent gas to the described excess pressure and releasing an amount of the reagent gas with impurities, may be an amount of time in a range from 30 minutes to 1000 hours, e.g., from 1 hour to 500 hours, such as from 2 hours to 100 hours.

The following is a series of preparation and handling steps of an example method of preparing adsorbent particles for use in a high-pressure vessel to store reagent gas.
1—Pressing high purity synthetic adsorbent particles such as PVDC copolymer or homopolymer into particles, pellets or tablets that will exhibit high particle density and high bulk density within a storage vessel.
2—Pyrolyze the particles in an inert atmosphere furnace using non-contaminated containment such as quartz or graphite trays or quartz rotary tube, in a recipe designed to eliminate all non-carbon byproducts under inert gas purge conditions.
3—Removing the pyrolyzed particles from the furnace in a manner that protects highly adsorbent carbon product from atmospheric exposure or other means of contamination.
4—Preparing highly polished, or coated, clean high-pressure (HP) cylinder. Cylinder preparation may include: cylinder shell washing to remove grease solvents, rust, etc.; cylinder shell mechanical, or mechano-chemical polishing that includes spinning or rolling a cylinder shell with metal, ceramic shots to smooth the roughness and removing a thin layer of the internal surface; further cleaning before loading carbon adsorbent using water steam followed by drying at elevated temperature and purging with clean inert gas; and optional passivation immediately before loading adsorbent.
5—Loading the high purity carbon particles into the cleaned, treated, and dried cylinder in a manner that minimizes atmospheric exposure or other sources of contamination. Example techniques may include connecting the cylinder inlet to an air free chamber adapted for loading the carbon adsorbent particles under an atmosphere that contains no measurable gaseous water and/or oxygen levels above 10 ppm, preferably below 1 ppm; loading the carbon adsorbent particles into the vessel through the vessel inlet under the low-water and low-oxygen conditions; and installing a valve at the vessel inlet while preventing air ingress.
6—Valving the HP cylinder can be followed by leak testing, evacuation, possible cycle purging with dry inert purge gas, and degassing at elevated temperature to high vacuum levels. The degassing step removes physisorbed and some chemisorbed species from the loaded carbon adsorbent particles that may have detrimental effect on adsorbed reagent gas (e.g., GeH₄) purity or carbon capacity for a reagent gas such as GeH₄.
7—Passivation of the carbon within the vessel to maintain high purity of adsorbed reagent gas (e.g., GeH₄) during storage by adsorbing small amount of sacrificial a reagent gas (e.g., GeH₄), heating for several hours to allow sacrificial reagent gas (e.g., GeH₄) to react with sites capable of decomposing the reagent gas (e.g., GeH₄) and inactivate them, followed by cooling and evacuation of gaseous product of the passivation reaction.
8—Cycle purging the vessel and adsorbent, then filling the vessel (now containing the fully degassed adsorbent) with reagent gas (e.g., the same reagent gas used in the passivation step) using a high purity gas manifold. Cycle purging refers to alternating cycles of applying high vacuum, and pressure (e.g., to 1 bar) with an inert purge gas such as helium, nitrogen, or argon, for an adequate number of cycles and at a sufficient temperature to remove adsorbed atmospheric gas species that may interact with a reagent gas that will become adsorbed on the adsorbate.

Optionally, the filled vessel may be handled using controlled storage and transportation conditions to further maintain purity, with “start-up” procedures at an end-use tool that are designed to reduce the levels of any impurities in the cylinder headspace. Examples of such steps may include temperature control during transport and warehousing; cylinder stabilization to ambient conditions prior to installation and use with a tool; and a step of venting cylinder headspace “gas phase” prior to extraction of adsorbed reagent gas for delivery to tool.

1. A storage system for storing adsorbed reagent gas, the system comprising:
a high pressure storage vessel comprising an interior that contains nano-porous pyrolyzed carbon adsorbent particles, and
reagent gas adsorbed on the adsorbent particles,
wherein a pressure at the interior is below 1500 torr.

2. The storage system of claim 1, wherein the adsorption media comprises pyrolyzed polyvinylidene chloride particles having an average particle size in a range from 1 to 10 millimeters.

3. The storage system of claim 1, wherein the adsorption media comprises pyrolyzed polyvinylidene chloride particles having an average pore size below 20 angstroms.

4. The storage system of claim 1, wherein the adsorbent comprises pyrolyzed polyvinylidene chloride particles having a bulk density in a range of 0.55 to 0.95 grams per cubic centimeter.

5. The storage system of claim 1, wherein the adsorbent comprises pyrolyzed polyvinylidene chloride particles having a particle density in a range of 0.85 to 1.15 grams per cubic centimeter.

6. The storage system of claim 1, wherein the storage system is capable of dispensing the reagent gas from the vessel with the dispensed reagent gas containing less than 150 parts per million (by volume, ppmv) of a total amount of impurities selected from H₂, CO, CO₂, N₂, CH₄, and H₂O, and combinations thereof.

7. The storage system of claim 1, wherein the storage vessel has an interior volume of at least 2 liters.

8. The storage system of claim 7, the adsorbed reagent gas comprising: methane (CH₄), acetylene (C₂H₂), ammonia (NH₃), silane (SiH₄), germane (GeH₄), diphosphene (P₂H₄) phosphine (PH₃), arsine (AsH₃), diborane (B₂H₆), stibine (SbH₃), hydrogen sulfide (H₂S), hydrogen selenide (H₂Se), hydrogen telluride (H₂Te), digermane (Ge₂H₆), diacetylene (C₄H₂), germanium tetrafluoride (GeF₄), phosphorous pentafluoride (PF₅), arsenic pentafluoride (AsF₅), silicon tetrafluoride (SiF₄), antimony pentafluoride (SbF₅), boron trifluoride (BF₃), boron tetrafluoride (B₂F₄), and all isotopes of these reagent gases.

9. The storage system of claim 7, wherein the adsorbed reagent gas is germane.

10. The storage system of claim 1, wherein the vessel contains the reagent gas at a concentration of at least 90 percent.

11. The storage system of claim 1 wherein the storage vessel has an internal pressure of not more than 760 torr.

12. The storage system of claim 1, wherein
the storage vessel has an internal pressure of not more than 760 torr, and
the storage vessel contains the reagent gas at a concentration of at least 90 percent.

13. The storage system of claim 1, wherein the storage vessel comprises:
polished sidewall surfaces having a roughness (Ra) of less than 1 nm,
non-welded sidewalls and bottom,
a volume of at least 10 liters.

14. A method of dispensing the adsorbed reagent gas from a storage system of claim 1, wherein the adsorbed reagent gas comprises: methane (CH₄), acetylene (C₂H₂), ammonia (NH₃), silane (SiH₄), germane (GeH₄), diphosphene (P₂H₄) phosphine (PH₃), arsine (AsH₃), diborane (B₂H₆), stibine (SbH₃), hydrogen sulfide (H₂S), hydrogen selenide (H₂Se), hydrogen telluride (H₂Te), digermane (Ge₂H₆), diacetylene (C₄H₂) germanium tetrafluoride (GeF₄), phosphorous pentafluoride (PF₅), arsenic pentafluoride (AsF₅), silicon tetrafluoride (SiF₄) , antimony pentafluoride (SbF₅), boron trifluoride (BF₃), boron tetrafluoride (B₂F₄), and all isotopes of these reagent gases.

15. A method of dispensing the adsorbed reagent gas from a storage system of claim 1, wherein the adsorbed reagent gas is germane.

16. A method of claim 15, comprising dispensing the germane from the vessel at concentration of at least 90 percent.

17. A method of dispensing the adsorbed reagent gas from a storage system of claim 1, comprising dispensing the reagent gas from the vessel with the dispensed reagent gas containing less than 150 parts per million (by volume, ppmv) of a total amount of impurities selected from H₂, CO, CO₂, N₂, CH₄, and H₂O, and combinations thereof.

18. A storage system for storing adsorbed reagent gas, the system comprising:
a high pressure storage vessel comprising:
polished sidewall surfaces having a roughness (Ra) of less than 1 nm,
non-welded sidewalls and bottom,
a volume of at least 10 liters, and
nano-porous pyrolyzed carbon adsorbent particles.

19. The storage system of claim 18, wherein the adsorption media comprises pyrolyzed polyvinylidene chloride particles having an average particle size in a range from 1 to 10 millimeters.

20. The storage system of claim 18, wherein the adsorption media comprises pyrolyzed polyvinylidene chloride particles having a pore size below 20 angstroms.

21. The storage system of claim 18, wherein the adsorbent comprises pyrolyzed polyvinylidene chloride particles having a bulk density in a range of 0.55 to 0.95 grams per cubic centimeter.

22. The storage system of claim 18, wherein the adsorbent comprises pyrolyzed polyvinylidene chloride particles having a particle density in a range of 0.85 to 1.15 grams per cubic centimeter.

23. A method of preparing carbon adsorbent particles, the method comprising:
forming synthetic polymer carbon precursor resin particles,
pyrolyzing the precursor resin particles in an inert atmosphere to produce nano-porous pyrolyzed carbon adsorbent particles,
placing the pyrolyzed carbon adsorbent particles into a high pressure storage vessel while containing the particles and the vessel in an inert gas atmosphere,
exposing the pyrolyzed carbon adsorbent particles in the vessel to elevated temperature and reduced pressure to remove atmospheric contaminants adsorbed on the particles and the vessel, and
filling the vessel with the reagent gas.

24. The method of claim 23 wherein the vessel is a high pressure storage vessel comprising:
polished sidewall surfaces having a roughness (Ra) of less than 1 nm,
non-welded sidewalls and bottom,
a volume of at least 10 liters.

25. The method of claim 24, wherein the adsorption media comprises pyrolyzed polyvinylidene chloride particles having an average particle size in a range from 1 to 10 millimeters.

26. The method of claim 24, wherein the adsorption media comprises pyrolyzed polyvinylidene chloride particles having an average pore size below 20 angstroms.

27. The method of claim 24, wherein the adsorbent comprises pyrolyzed polyvinylidene chloride particles having a bulk density in a range of 0.55 to 0.95 grams per cubic centimeter.

28. The method of claim 24, wherein the adsorbent comprises pyrolyzed polyvinylidene chloride particles having a particle density in a range of 0.85 to 1.15 grams per cubic centimeter.
